(19) United States
(12) Patent Application Publication
(10) Pub. No.: US 2016/0232727 A1
(43) Pub. Date: Aug. 11, 2016

(54) CONTROL SYSTEM AND CONTROL METHOD FOR VEHICLE ANTI-THEFT

(71) Applicant: HON HAI PRECISION INDUSTRY CO., LTD., New Taipei (TW)

(72) Inventor: CHI-TUNG WANG, New Taipei (TW)

(21) Appl. No.: 14/740,409

(22) Filed: Jun. 16, 2015

(30) Foreign Application Priority Data
Feb. 10, 2015 (TW) 104104465

(51) Int. Cl. G07C 9/00

(52) U.S. Cl. CPC G07C 9/00111

(57) ABSTRACT

A control method for vehicle anti-theft is provided. The control method is running on a vehicle and a smart key. The control method includes: transmitting a low-frequency signal; analyzing a magnetic intensity of the low-frequency signal received by a low-frequency receive unit of a smart key when the smart key is within a predefined distance of the vehicle; transmitting a high-frequency signal containing the magnetic intensity; getting a time duration between a first time that the low-frequency signal is transmitted and a second time that the high-frequency signal is received; calculating a propagation distance according to the time duration; obtaining a predefined magnetic intensity range corresponding to the propagation distance from the vehicle; determining whether the magnetic intensity is within the predefined magnetic intensity range and unlocking the vehicle when the magnetic intensity is within the predefined magnetic intensity range.

### FIELD

The subject matter herein generally relates to control systems and control methods for vehicle anti-theft.

### BACKGROUND

PKES (Passive Keyless Entry System) refers to a communication between a vehicle and a smart key via the vehicle transmitting the low-frequency signals and the smart key returning the high-frequency signals after receiving the low frequency signals so as to achieve opening the door of the vehicle.

The effective propagation distance of the low-frequency signals can be 2-3 meters, that is, only when the user is very close to the vehicle, the smart key can receive the low-frequency signals, such that a verification process can be started. However, the low-frequency signals can be multiplied by a third part, such that the low-frequency signals can be propagated to a much far distance, and the vehicle can be thus easily relayed and thefted.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure.

Moreover, in the drawings, like reference numerals designate corresponding parts throughout the views.

FIG. 1 is a block diagram of an embodiment of a control system for vehicle anti-theft.

FIG. 2 is a block diagram of an embodiment of an operating environment of the control system for vehicle anti-theft shown in FIG. 1.

FIGS. 3 and 4 cooperatively constitute a signal flowchart of an embodiment of a control method for vehicle anti-theft.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

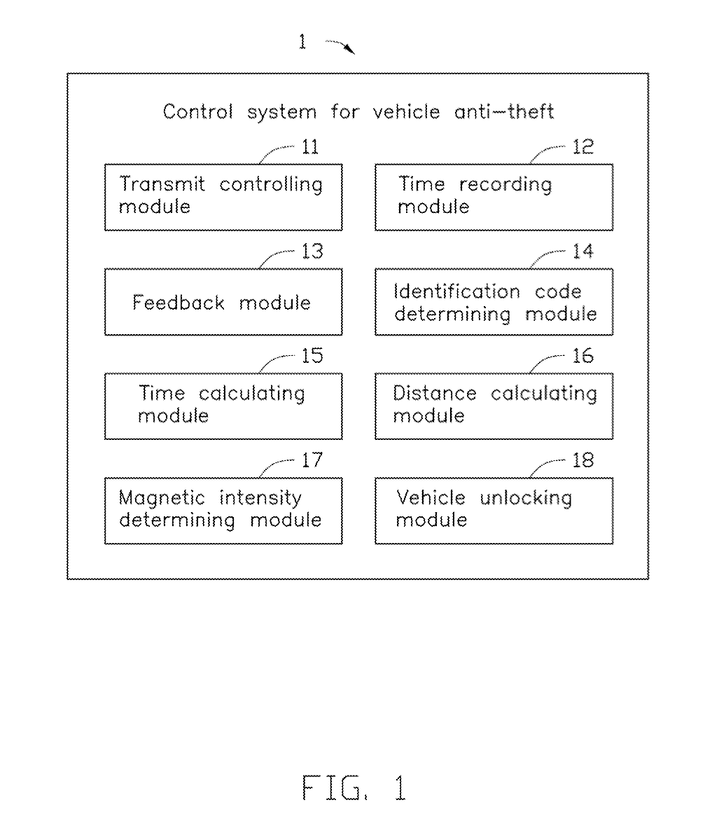

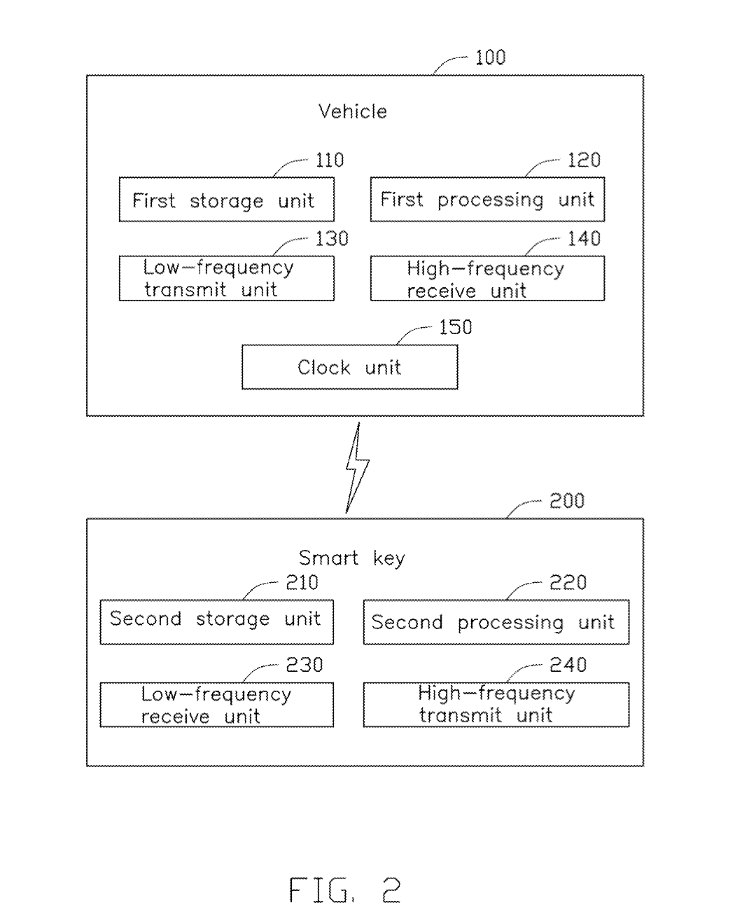

FIG. 1 shows a control system for vehicle anti-theft 1. The control system 1 can be run on but not limited to a vehicle 100 and a smart key 200 which are shown on FIG. 2.

The vehicle 100 can include a first storage unit 110, a first processing unit 120, a low-frequency transmit unit 130, a high-frequency receive unit 140 and a clock unit 150.

The low-frequency transmit unit 130 can be attached to any locations of the vehicle 100, such as a front side of a driver's seat, a left side of the driver's seat, a right side of the driver's seat, a left side of a passenger's seat, a right side of the passenger's seat, a left side of a back seat, a right side of the back seat, or a back side of the back seat, or the like. The low-frequency transmit unit 130 can be used to transmit a low-frequency signal. The magnetic intensity of the low-frequency signal can be decreased rapidly with the distance increasing between the low-frequency signal and the low-frequency transmit unit 130. Furthermore, if the distance between the low-frequency signal and the low-frequency transmit unit 130 is greater than a predefined distance, the magnetic intensity of the low-frequency signal can be attenuated to zero.

The first storage unit 110 can be used to store a relationship recording a number of propagation distances and a number of predefined magnetic intensity ranges of a low-frequency signal.

The first storage unit 110 can further store data including a predefined identification code, and the predefined identification code can be used to verify an identity of the smart key 200.

The clock unit 150 can be used to time.

The smart key 200 can include a second storage unit 210, a second processing unit 220, a low-frequency receive unit 230 and a high-frequency transmit unit 240.

The second storage unit 210 can be used to store an identification code of the smart key 200.

In at least one embodiment, the first storage unit 110 and the second storage unit 210 can be an internal storage system, such as a flash memory, a random access memory (RAM) for temporary storage of information, and/or a read-memory (ROM) for permanent storage of information.

In at least one embodiment, the first storage unit 110 and the second storage unit 210 can also be a storage system, such as a hard disk, a storage card, or a data storage medium. The first storage unit 110 and the second storage unit 210 can include volatile and/or non-volatile storage devices.

In at least one embodiment, the first storage unit 110 and the second storage unit 210 can include two or more storage devices such that one storage device is a memory and the other storage device is a hard drive. Additionally, the first storage unit 110 and the second storage unit 210 can be respectively located either entirely or partially external relative to the vehicle 100.

In at least one embodiment, the first processing unit 120 and the second processing unit 220 can be a central processing unit, a digital signal processor, or a single chip, for example.

Referring to FIG. 1, the control system 1 can include a number of modules, and the number of modules can include a transmit controlling module 11, a time recording module 12, a feedback module 13, an identification code determining module 14, a time calculating module 15, a distance calculating module 16, a magnetic intensity determining module 17 and a vehicle unlocking module 18. The number of modules can be stored in the first storage unit 110 and/or the second storage unit 210, and further applied on the first processing unit 120 and/or the second processing unit 220. In this embodiment, the transmit controlling module 11, the time recording module 12, the identification code determining module 14, the time calculating module 15, the distance calculating module 16, the magnetic intensity determining module 17 and the vehicle unlocking module 18 can be stored in the first storage unit 110, and further applied on the first processing unit 120, and the feedback module 13 can be stored in the second storage unit 210, and further applied on the second processing unit 220. The details are as follows. The modules of the control system 1 can include separated functionalities represented by hardware or integrated circuits, or as software and hardware combinations, such as a special-purpose processor or a general-purpose processor with special-purpose firmware.

The transmit controlling module 11 can be used to control the low-frequency transmit unit 130 to transmit a low-frequency signal having a predefined magnetic intensity.

The time recording module 12 can be used to obtain a first time recorded by the clock unit 150 when the low-frequency signal has been transmitted and further control the first storage unit 110 to store the first time.

The low-frequency receive unit 230 of the smart key 200 can receive the low-frequency signal when the smart key 200 is within a predefined distance of the vehicle 100. As the magnetic intensity of the low-frequency signal can be decreased rapidly with the distance increasing between the low-frequency signal and the low-frequency transmit unit 130 of the vehicle 100, so the magnetic intensity of the received low-frequency signal can be substantially less than the predefined magnetic intensity.

The feedback module 13 can be used to analyze the magnetic intensity of the received low-frequency signal, obtain the identification code of the smart key 200 from the second storage unit 210, and further control the high-frequency transmit unit 240 to transmit a high-frequency signal containing the magnetic intensity of the received low-frequency signal and the identification code of the smart key 200.

The high-frequency receive unit 140 of the vehicle 100 can receive the high-frequency signal when the vehicle 100 is within a predefined distance of the smart key 200. The time recording module 12 can be further used to obtain a second time recorded by the clock unit 150 when the high-frequency signal has been received and further control the first storage unit 110 to store the second time.

The identification code determining module 14 can be used to obtain the identification code from the high-frequency signal, and obtain the predefined identification code from the first storage unit 110, and further determine whether the identification code matches with the predefined identification code.

The time calculating module 15 can be used to obtain the first time and the second time from the first storage unit 110 and further calculate a time duration between the first time and the second time when the identification code matches with the predefined identification code.

The distance calculating module 16 can be used to calculate a propagation distance according to the time duration, and the propagation distance can be the time duration multiplied by a light transportation speed and further divided by two.

The magnetic intensity determining module 17 can be used to obtain a predefined magnetic intensity range corresponding to the propagation distance from the first storage unit 110, and obtain the magnetic intensity from the received high-frequency signal, and further determine whether the magnetic intensity is within the predefined magnetic intensity range.

The unlocking module 18 can be used to unlock the vehicle 100 when the magnetic intensity is within the predefined magnetic intensity range, otherwise, the vehicle 100 cannot be unlocked, which can effectively avoid vehicle anti-theft.

In at least one embodiment, the time recording module 12 can control the clock unit 150 to start timing when the low-frequency signal is transmitted, and further control the clock unit 150 to stop timing when the high-frequency signal is received, and the time calculating module 15 can be thus omitted.

In at least one embodiment, the process of identification code determination can be omitted, and the identification code determining module 14 can be thus omitted.

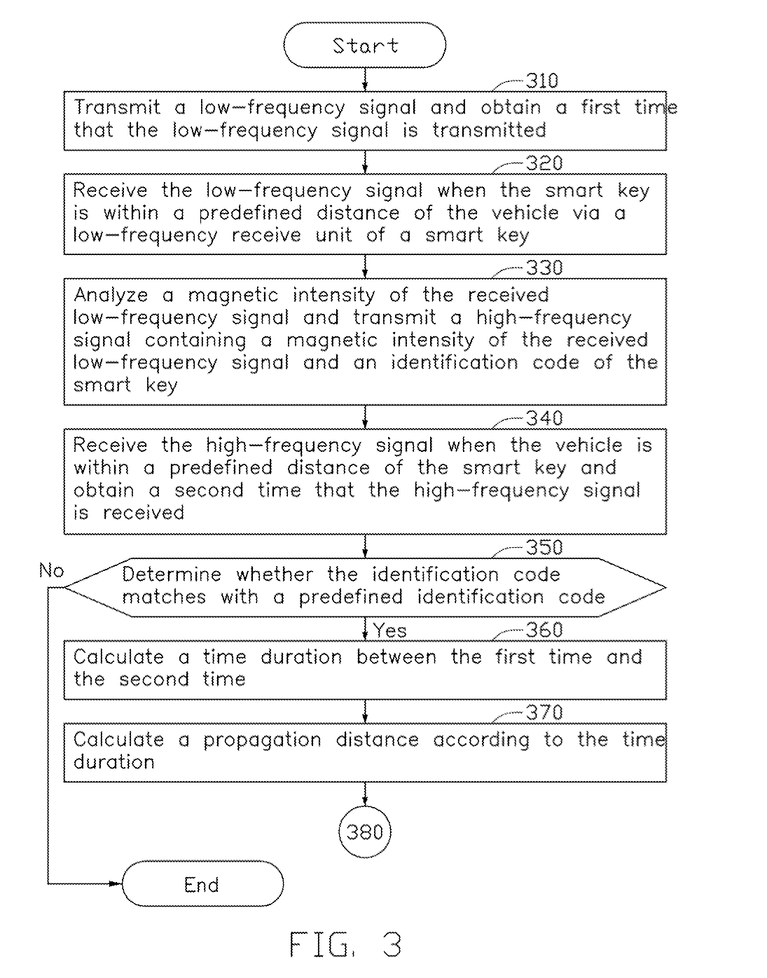

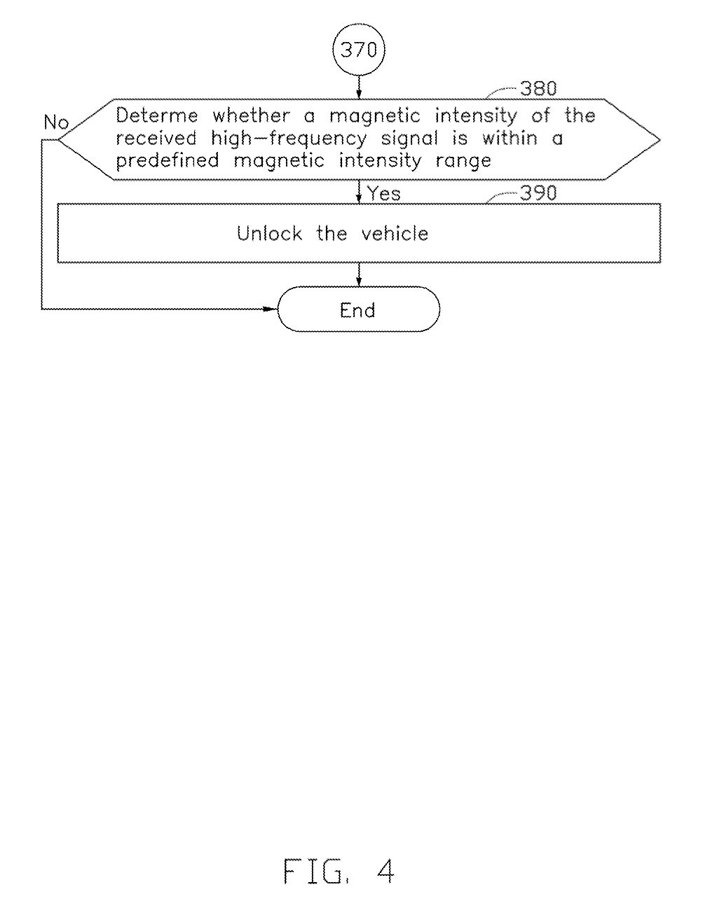

FIGS. 3 and 4 cooperatively illustrate a signal flowchart of a control method for vehicle anti-theft. The control method is provided by way of example, as there are a variety of ways to carry out the method. The control method described below can be carried out using the configurations illustrated in FIG. 1, for example, and various elements of these figures are referenced in explaining the example method. Each block shown in FIGS. 3 and 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 310.

At block 310, a vehicle transmits a low-frequency signal and further obtains a first time that the low-frequency signal is transmitted. In detail, a transmit controlling module controls a low-frequency transmit unit of the vehicle to transmit a low-frequency signal having a predefined magnetic intensity, and a time recording module obtains the first time recorded by a clock unit of the vehicle that the low-frequency signal is transmitted and further controls a first storage unit of the vehicle to store the first time.

At block 320, a low-frequency receive unit of a smart key receives the low-frequency signal when the smart key is within a predefined distance of the vehicle.

At block 330, the smart key analyzes a magnetic intensity of the received low-frequency signal and transmits a high-frequency signal containing a magnetic intensity of the received low-frequency signal and an identification code of the smart key. In detail, a feedback module analyzes the magnetic intensity of the received low-frequency signal, obtains an identification code of the smart key from a second storage unit of the smart key, and further controls a high-frequency transmit unit of the smart key to transmit the high-frequency signal containing the magnetic intensity of the received low-frequency signal and the identification code of the smart key.

At block 340, the vehicle receives the high-frequency signal when the vehicle is within a predefined distance of the smart key and further obtains a second time that the high-frequency signal is received. In detail, a high-frequency receive unit receives the high-frequency signal when the vehicle is within the predefined distance of the smart key, and the time recording module further obtains the second time recorded by the clock unit when the high-frequency signal is received and further controls the first storage unit of the vehicle to store the second time.

At block 350, the vehicle determines whether the identification code matches with a predefined identification code, if yes, the process goes to block 360, otherwise, the process goes to end. In detail, an identification code determining module obtains the identification code from the high-frequency signal, and obtains the predefined identification code from the first storage unit of the vehicle, and further determines whether the identification code matches with the predefined identification code, if yes, the process goes to block 360, otherwise, the process goes to end.

At block 360, the vehicle calculates a time duration between the first time and the second time. In detail, a time calculating module obtains the first time and the second time from the first storage unit and further calculates the time duration between the first time and the second time.

At block 370, the vehicle calculates a propagation distance according to the time duration. In detail, a distance calculating module calculates the propagation distance according to the time duration, and the propagation distance can be the time duration multiplied by a light transportation speed and further divided by two.

At block 380, the vehicle determines whether a magnetic intensity of the received high-frequency signal is within a predefined magnetic intensity range, if yes, the process goes to block 390, otherwise, the process goes to end. In detail, a magnetic intensity determining module obtains the predefined magnetic intensity range corresponding to the propagation distance, and obtains the magnetic intensity from the received high-frequency signal, and further determines whether the magnetic intensity is within the predefined magnetic intensity range, if yes, the process goes to block 390, otherwise, the process goes to end.

At block 390, the vehicle is unlocked. In detail, an unlocking module unlocks the vehicle.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A control system for vehicle anti-theft comprising:
at least one processing unit; and
a plurality of modules coupled to the at least one processing unit, each of the plurality of modules including instructions to be executed by one or more of the at least one processing unit, the plurality of modules comprising:
a transmit controlling module configured to cause the at least one processing unit to control a low-frequency transmit unit of a vehicle to transmit a low-frequency signal;
a feedback module configured to cause the at least one processing unit to analyze a magnetic intensity of the low-frequency signal received by a low-frequency receive unit of a smart key when the smart key is within a predefined distance of the vehicle, obtain an identification code from the smart key, and further control a high-frequency transmit unit of the smart key to transmit a high-frequency signal containing the magnetic intensity;
a time recording module configured to cause the at least one processing unit to get a time duration between a first time that the low-frequency signal is transmitted via the low-frequency transmit unit of the vehicle and a second time that the high-frequency signal is received via a high-frequency receive unit of the vehicle;
a distance calculating module configured to cause the at least one processing unit to calculate a propagation distance according to the time duration;
a magnetic intensity determining module configured to cause the at least one processing unit to obtain a predefined magnetic intensity range corresponding to the propagation distance from the vehicle, and obtain a magnetic intensity from the received high-frequency signal to determine whether the magnetic intensity is within the predefined magnetic intensity range; and
an unlocking module configured to cause the at least one processing unit to unlock the vehicle when the magnetic intensity is within the predefined magnetic intensity range.

2. The control system of claim 1, wherein the unlocking module is configured to not unlock the vehicle when the magnetic intensity is not within the predefined magnetic intensity range.

3. The control system of claim 1, wherein the received high-frequency signal further contains an identification code, the plurality of modules further comprises:
an identification code determining module configured to cause the at least one processing unit to obtain the identification code from the high-frequency signal and obtain a predefined identification code from the vehicle to determine whether the identification code matches with the predefined identification code;
wherein the unlocking module is configured to unlock the vehicle when the magnetic intensity is within the predefined magnetic intensity range and the identification code matches with the predefined identification code.

4. The control system of claim 3, wherein the unlocking module is not configured to unlock the vehicle when the magnetic intensity is not within the predefined magnetic intensity range or the identification code does not match with the predefined identification code.

5. The control system of claim 1, wherein the time recording module is configured to control a clock unit of the vehicle to record the first time that the low-frequency signal is transmitted and the second time that the high-frequency signal is received; the plurality of modules further comprises:
a time calculating module configured to cause the at least one processing unit to calculate the time duration between the first time and the second time.

6. The control system of claim 1, wherein the propagation distance is the time duration multiplied by a light transportation speed and further divided by two.

7. A control method for vehicle anti-theft comprising:
controlling a low-frequency transmit unit of a vehicle to transmit a low-frequency signal;
analyzing a magnetic intensity of the low-frequency signal received by a low-frequency receive unit of a smart key when the smart key is within a predefined distance of the vehicle, and controlling a high-frequency transmit unit of the smart key to transmit a high-frequency signal containing the magnetic intensity;
getting a time duration between a first time that the low-frequency signal is transmitted via the low-frequency transmit unit of the vehicle and a second time that the high-frequency signal is received via a high-frequency receive unit of the vehicle;
calculating a propagation distance according to the time duration;
obtaining a predefined magnetic intensity range corresponding to the propagation distance from the vehicle, and obtaining a magnetic intensity from the received high-frequency signal to determine whether the magnetic intensity is within the predefined magnetic intensity range; and
unlocking the vehicle when the magnetic intensity is within the predefined magnetic intensity range.

8. The control method of claim 7, the control method further comprising:
not unlocking the vehicle when the magnetic intensity is not within the predefined magnetic intensity range.

9. The control method of claim 7, wherein the received high-frequency signal further contains an identification code, the control method comprises:
obtaining the identification code from the high-frequency signal, and obtaining a predefined identification code from the vehicle to determine whether the identification code matches with the predefined identification code; and
unlocking the vehicle when the magnetic intensity is within the predefined magnetic intensity range and the identification code matches with the predefined identification code.

10. The control method of claim 9, the control method further comprising:
not unlocking the vehicle when the magnetic intensity is not within the predefined magnetic intensity range or the identification code does not match with the predefined identification code.

11. The control method of claim 7, wherein getting a time duration between a first time that the low-frequency signal is transmitted via the low-frequency transmit unit of the vehicle and a second time that the high-frequency signal is received via a high-frequency receive unit of the vehicle comprises:
controlling a clock unit of the vehicle to record the first time that the low-frequency signal is transmitted via the low-frequency transmit unit of the vehicle;
controlling the clock unit of the vehicle to record the second time that the high-frequency signal is received via the high-frequency receive unit of the vehicle; and
calculating the time duration between the first time and the second time.

12. The control method of claim 7, wherein the propagation distance is the time duration multiplied by a light transportation speed and further divided by two.

13. A control method for vehicle anti-theft, running on a vehicle, the control method comprising:
controlling a low-frequency transmit unit of the vehicle to transmit a low-frequency signal, wherein the low-frequency signal is received by a smart key;
receiving a high-frequency signal containing a magnetic intensity of the low-frequency signal that is received by the smart key;
getting a time duration between a first time that the low-frequency signal is transmitted via the low-frequency transmit unit of the vehicle and a second time that the high-frequency signal is received via a high-frequency receive unit of the vehicle;
calculating a propagation distance according to the time duration;
obtaining a predefined magnetic intensity range corresponding to the propagation distance from the vehicle, and obtaining a magnetic intensity from the received high-frequency signal to determine whether the magnetic intensity is within the predefined magnetic intensity range; and
unlocking the vehicle when the magnetic intensity is within the predefined magnetic intensity range.

14. The control method of claim 13, the control method further comprising:
not unlocking the vehicle when the magnetic intensity is not within the predefined magnetic intensity range.

15. The control method of claim 13, wherein the received high-frequency signal further contains an identification code, the control method comprises:
obtaining the identification code from the high-frequency signal, and obtaining a predefined identification code from the vehicle to determine whether the identification code matches with the predefined identification code; and
unlocking the vehicle when the magnetic intensity is within the predefined magnetic intensity range and the identification code matches with the predefined identification code.

16. The control system of claim 15, the control method comprising:
not unlocking the vehicle when the magnetic intensity is not within the predefined magnetic intensity range or the identification code does not match with the predefined identification code.

17. The control method of claim 13, wherein getting a time duration between a first time that the low-frequency signal is transmitted via the low-frequency transmit unit of the vehicle and a second time that the high-frequency signal is received via a high-frequency receive unit of the vehicle comprising
controlling a clock unit of the vehicle to record the first time that the low-frequency signal is transmitted via the low-frequency transmit unit of the vehicle;
controlling the clock unit of the vehicle to record the second time that the high-frequency signal is received via the high-frequency receive unit of the vehicle; and
calculating the time duration between the first time and the second time.

18. The control method of claim 13, wherein the propagation distance is the time duration multiplied by a light transportation speed and further divided by two.
